(19) United States
(12) Patent Application Publication
(10) Pub. No.: US 2026/0107891 A1
(43) Pub. Date: Apr. 23, 2026

(54) METHOD OF PRODUCING ASPARAGOPSIS

(71) Applicant: SeaStock Pty Ltd, Fremantle (AU)

(72) Inventors: Thanh Hoang HAI, Adelaide (AU); Pengfei FU, Otago (AU); Tom CHANEY, East Fremantle (AU)

(21) Appl. No.: 19/473,002

(22) PCT Filed: Apr. 5, 2024
(86) PCT No.: PCT/AU2024/050333

§ 371 Date: Oct. 30, 2025

(30) Foreign Application Priority Data
Apr. 5, 2023 (AU) 2023901004

(51) Int. Cl. A01G 33/00

(52) U.S. Cl. CPC A01G 33/00

(57) ABSTRACT

Methane production in ruminant animals may be reduced by improving rumen fermentation efficiency through dietary supplementation of Asparagopsis taxiformis. The present disclosure relates to a method of producing A. taxiformis and uses thereof. In particular forms, the present disclosure relates to methods of producing a tetrasporophyte and a gametophyte of A. taxiformis through environmental manipulations.

### TECHNICAL FIELD

The present disclosure relates to a method of producing Asparagopsis taxiformis. In particular forms, the present disclosure relates to methods of producing a tetrasporophyte and a gametophyte of A. taxiformis through environmental manipulations.

### PRIORITY DOCUMENT

The present application claims priority from Australian Provisional Patent Application No. 2023901004 titled “METHODS OF PRODUCING ASPARAGOPSIS” and filed on 5 Apr. 2023, the entire contents of which is herein incorporated by reference in its entirety.

### BACKGROUND

The report of the global greenhouse emission by gas for the period of 2000-2010, published by the Intergovernmental Panel on Climate Change (IPCC), Climate Change 2013/2014, highlighted that methane is the second most abundant contributor of greenhouse gas (GHG), just after carbon dioxide (CO₂) and accounted for about 16% of global emissions (IPCC, 2015). Importantly, a small amount of methane can significantly impact global warming as it is far more effective at trapping heat from the atmosphere than other gases, such as carbon dioxide (Howarth, 2014). Human-related activities such as producing energy, managing wastes, industrial manufacturing, and agriculture have significantly contributed to a dramatic increase in methane concentration in the atmosphere over the last few centuries (Bačeninaitė et al., 2022; Karakurt et al., 2012). Notably, methane production from enteric fermentation, a natural part of the digestive process in ruminant animals, contributed to 59.84% of emissions from agriculture (Karakurt et al., 2012). Therefore, reducing enteric CH₄ emissions is urgently needed to manage global warming and climate change.

A proposed solution to lower methane production in ruminant animals is improving rumen fermentation efficiency (Karakurt et al., 2012). This involves supplementing feed to reduce the number of methanogenic archaebacteria. Red algae in the form of feed additives have been proven to inhibit the growth of methanogenic archaebacteria, which produce methane gas (Abbott et al., 2020; Machado et al., 2015). Among red algae, the species in the Asparagopsis genus exhibit the greatest potential for reducing methane emissions as they contain abundant bioactive bromoform that could reduce the number of rumen methanogens (Abbott et al., 2020; Bačeninaitė et al., 2022; Machado et al., 2016). Methanogens rely on the Wolfe cycle for formation of methane, in which carbon dioxide (CO₂) is reduced to methane (CH₄) using hydrogen (H₂). Bromoform competes with substrates of the enzymes methyl coenzyme M reductase and methyl coenzyme M transferase to inhibit the methyl transfer and release of methane from methyl coenzyme M. Recent research showed that adding a small amount of this red algae to cattle feed significantly decreased the level of methane emissions without negatively affecting animal performance (Kinley et al., 2016; Machado et al., 2016a,b). According to Stefenoni et al. (2021), the inclusion of 1% dry matter of A. taxiformis to the growth medium resulted in a reduction of methane level by 98% in in vitro assays. For in vivo studies, dietary supplementation of 0.20% organic matter of A. taxiformis reduced methane production by 98% methane in feedlot beef cattle without an adverse impact on meat quality, while the growth rate was slightly improved at 42%. Bromoform was below the detection level in the meat, fat, organs, or feces of the experimental animals (Kinley et al., 2020). Stefenoni et al. (2021) reported that dairy cows supplemented with either low (0.25%) or high (0.5% dry matter) levels of A. taxiformis produced 65% and 55% less methane, respectively. Similarly, steers fed with low (0.25%) and high (0.5%) levels of A. taxiformis over 147 days produced 45% and 68% less methane. (Roque et al., 2021). Additionally. A. taxiformis can effectively minimise methane emissions in other ruminants such as sheep (Li et al. 2016). However, the commercial aquaculture of A. taxiformis is still very much in its infancy, and little is currently known about its reproduction and cultivation techniques.

A. taxiformis is sexual, heteromorphic, and has a triphasic life cycle (Bonin and Hawkes 1987; Zanolla et al., 2014). A. taxiformis grows on rocky shores and reefs in tropical and warm-temperate parts of the Indo-Pacific and Atlantic oceans. The gametophyte stage has dark brown-red colour, feathery branches up to 40 cm high and is attached via rhizoids (Zanolla et al., 2014). The main branches are covered with densely and irregularly radially branched laterals, mostly 1-2 cm long (Zanolla et al., 2022). The carposporophyte phase is identified by the presence of cystocarps and spermatangia (Bonin and Hawkes 1987; Zanolla et al., 2014; Zanolla et al., 2022). The red “pompom” shape filament, the tetrasporophyte stage (diploid), is completely different in appearance from both gametophyte (haploid) and carposporophyte (diploid) stages (Abbott 1999). They are often found growing epiphytically on other algae in the intertidal zone to 15 m depths or free-floating (Huisman et al. 2007; Zanolla et al., 2022). Recently, research has begun on each of the phases of the life cycle of A. taxiformis for use in aquaculture.

The tetrasporophyte can be vegetatively propagated by tearing off filaments into smaller parts and has been successfully grown in different culturing systems (Schuenhoff et al. 2006; Mata 2008; Mata et al. 2007, 2010, 2012). Currently, the starting material of tetrasporophytes is either collected from the wild or induced via excising the cystocarps to obtain carpospores and germinate carpospores into young tetrasporophytes (Mata et al., 2017; Schuenhoff et al. 2006; Paul et al., 2006). However, wild tetrasporophyte filaments contain several contaminating species and require heavy and complicated cleaning processes. Further, the current method of excising cystocarps for releasing carpospores involves manual work, which is time-consuming and has a high labour cost. Furthermore, the gametophyte phase of A. taxiformis has not been successfully cultured in the laboratory facilities and decays rapidly (Zanolla et al., 2022).

Therefore, there is a need to develop techniques that can provide commercial-scale production of tetrasporophytes and gametophytes of Asparagopsis in land-based farming or onshore culturing systems.

### SUMMARY

The present disclosure arises from research into methods of culturing A. taxiformis to naturally, sustainably and commercially produce tetrasporophytes and gametophytes in controlled environments.

According to a first aspect, there is provided a method of producing at least one tetrasporophyte of A. taxiformis, comprising:
providing an A. taxiformis carposporophyte with at least one mature cystocarp;
incubating the carposporophyte at a temperature in the range of about 20 to about 26 degrees Celsius (C) with exposure to light at an intensity in the range of about 80 to about 170 μmol m⁻²s⁻¹ for a first time exposure period in the range of about 10 to about 48 hours to induce at least one carpospore to release from the at least one cystocarp; and
incubating the at least one carpospore at a temperature in the range of about 20 to about 26 degrees C. with exposure to light at an intensity in the range of about 80 to about 170 μmol m⁻²s⁻¹ for a second time exposure period in the range of about 10 to about 72 hours to induce the at least one carpospore to germinate to produce the at least one tetrasporophyte.

In certain embodiments, a duration of the light in either or both of the first and second time exposure periods is in the range about 16 to about 24 hours per 24 hours. In certain embodiments, the duration of the light in either or both of the first and second time exposure periods is substantially continuous.

In certain embodiments, the light intensity in either or both of the first and second time exposure periods is in the range of about 120 to about 170 μmol m⁻²s⁻¹. In certain embodiments, the light intensity in either or both of the first and second time exposure periods is in the range of about 140 to about 150 μmol m⁻²s⁻¹.

In certain embodiments, the incubation temperature of the first and second time exposure periods is in the range of 21-25 degrees. In particular embodiments, the incubation temperature of the first and second time exposure periods is in the range of 22-24 degrees.

In some embodiments, prior to the first time exposure period, the method comprises a pre-incubation wherein a temperature of the carposporophyte is adjusted from a first temperature (eg as provided in a medium, such as sea water) to the incubation temperature of the first time exposure period. As such, in certain embodiments, the method comprises a pre-incubation comprising incubating the carposporophyte at a temperature that is adjusted from a first temperature to the temperature of the first time exposure period (eg in the range of about 20 to about 26 degrees C.).

In certain embodiments, the first temperature is in the range of about 17 to about 23 degrees C.

In certain embodiments, the temperature in the pre-incubation is adjusted in the range of about 1 to about 8 degrees.

In certain embodiments, the temperature in the pre-incubation is adjusted at a rate in the range of about 0.25 to about 3 degrees C. per hour.

According to a second aspect, there is provided a method of producing at least one gametophyte of A. taxiformis, comprising:
providing an A. taxiformis tetrasporophyte;
incubating the tetrasporophyte at a temperature in the range of about 20 to about 26 degrees C. with exposure to light at an intensity in the range of about 30 to about 100 μmol m⁻²s⁻¹ for a time exposure period in the range of about 5 to about 30 days to induce growth of at least one gametophyte thallus; and optionally, before inducing the growth of the at least one gametophyte thallus, first inducing formation of a tetrasporangium containing a tetraspore, inducing the tetrasporangium to release the tetraspore, and inducing the tetraspore to germinate to produce the at least one gametophyte thallus.

In certain embodiments, a duration of the light in the time exposure period is in the range of about 6 to about 18 hours per 24 hours. In certain embodiments, the duration of the light in the time exposure period is in the range of about 7 to about 16 hours per 24 hours.

In certain embodiments, the light intensity in the time exposure period is in the range of about 40 to about 80 μmol m⁻²s⁻¹. In certain embodiments, the light intensity in the time exposure period is in the range of about 50 to about 70 μmol m⁻²s⁻¹.

In certain embodiments, the incubation temperature of the time exposure period is in the range of about 21 to about 25 degrees. In particular embodiments, the incubation temperature of the time exposure period is in the range of about 22 to about 24 degrees.

In certain embodiments, the time exposure period is in the range of about 6 to about 21 days.

In certain embodiments, the method of the second aspect further comprises: before inducing the growth of the at least one gametophyte thallus, first inducing the formation of the tetrasporangium containing the tetraspore, inducing the tetrasporangium to release the tetraspore, and inducing the tetraspore to germinate to produce the at least one gametophyte thallus.

In certain embodiments, the tetrasporophyte is produced by the method of the first aspect.

In certain embodiments, the at least one tetrasporophyte is developed to be ready to produce the at least one gametophyte by steps comprising:
incubating the at least one tetrasporophyte at a temperature in the range of about 20 to about 26 degrees C. with exposure to light at an intensity in the range of about 30 to about 100 μmolm⁻²s⁻¹ for a third time exposure period in the range of about 16 to about 24 hours per 24 hours for about 30 to about 90 days to increase a biomass of the at least one tetrasporophyte; and
incubating the at least one tetrasporophyte at a temperature in the range of about 20 to about 26 degrees C. with exposure to light at an intensity in the range of about 30 to about 100 μmolm⁻²s⁻¹ for a fourth time exposure period in the range of about 8 to about 16 hours per 24 hours for about 30 to about 90 days to develop the at least one tetrasporophyte to be ready to produce the at least one gametophyte.

According to a third aspect, there is provided an A. taxiformis tetrasporophyte produced by the method of the first aspect.

According to a fourth aspect, there is provided an A. taxiformis gametophyte produced by the method of the second aspect.

According to a fifth aspect, there is provided a composition comprising at least one A. taxiformis tetrasporophyte of the third aspect or A. taxiformis gametophyte of the fourth aspect, or an extract(s) of said tetrasporophyte or gametophyte comprising one or more halogenated compound(s).

According to a sixth aspect, there is provided an animal feed supplement comprising an effective amount of the composition of the fifth aspect.

### BRIEF DESCRIPTION OF DRAWINGS

Embodiments of the present disclosure will be discussed with reference to the accompanying drawings wherein:

FIG. 1 is a diagram of the life cycle of A. taxiformis;

FIG. 2 is a photograph of the A. taxiformis branches selected for inducing carpospores;

FIG. 3 is a photograph of a cystocarp naturally releasing carpospores of A. taxiformis;

FIG. 4 is a photograph of germinating carpospores of A. taxiformis;

FIG. 5 is a photograph of healthy tetrasporophytes of A. taxiformis under conditions of 8 hours of light per 24 hours;

FIG. 6 is a photograph of pale coloured tetrasporophytes of A. taxiformis under conditions of continuous light (ie 24 hours of light per 24 hours);

FIG. 7 is a photograph of young gametophytes of A. taxiformis under 5× magnification from an 8 hours light per 24 hours (8 L/16D) treatment;

FIG. 8 is a photograph of a gametophyte developed from a tetrasporophyte body; and

FIG. 9 is a photograph of early stage gametophytes.

### DESCRIPTION OF EMBODIMENTS

As used herein, the term “about” means plus or minus 5% for a given number, eg, a time exposure of 10 hours±5% is 9.5-10.5 hours, or an incubation temperature of 22 degrees C.±5% is 20.9-23.1 degrees C. As used herein, the statement “in the range of about” and “to about” means plus or minus 5% for a given number, eg, in the range of about 20 to about 26 degrees means a range of 20 degrees C.±5% is 21-23 degrees C. to 26 degrees±5% is 24.7-27.3 degrees C. As the person skilled in the art would appreciate, the term “about” may be removed to improve precision or clarity.

The commercial-scale production of A. taxiformis is facing challenges due to limited stocks in the wild. Current research is attempting to recreate the life cycle of gametophyte, carposporophyte and tetrasporophyte stages in the laboratory. Currently, there are two ways to obtain tetrasporophytes: 1) collecting mature cystocarps from the wild and manually excising them to obtain carpospores and germinating the carpospores, which then develop into young tetrasporophytes; and 2) collecting tetrasporophytes from the wild. Those methods have many disadvantages. They are time-consuming, labour-intensive, and have a low hatching rate and a low germination rate. Furthermore, wild tetrasporophytes are covered by many contaminating organisms, which are hard to remove, and so it is difficult to obtain clean tetrasporophytes.

The present disclosure arises from research into methods of culturing A. taxiformis. The research involves culturing A. taxiformis through different phases of the triphasic life cycle shown in FIG. 1. The present inventors have developed methods to produce tetrasporophytes and gametophytes. Broadly, the methods involve inducing and germinating carpospores via environmental manipulation and growing those into tetrasporophytes. This can rapidly produce a large and clean biomass of tetrasporophytes. Further, the methods involve further environmental manipulation for the production of gametophytes.

According to the first aspect, there is provided a method of producing at least one tetrasporophyte of A. taxiformis, comprising:
providing an A. taxiformis carposporophyte with at least one mature cystocarp;
incubating the carposporophyte at a temperature in the range of about 20 to about 26 degrees Celsius (degrees C.) and with exposure to light at an intensity in the range of about 80 to about 170 μmol m⁻²s⁻¹ for a first time exposure period in the range of about 10 to about 48 hours to induce at least one carpospore to release from the at least one cystocarp; and incubating the at least one carpospore at a temperature in the range of about 20 to about 26 degrees C. with exposure to light at an intensity in the range of about 80 to about 170 μmolm⁻²s⁻¹ for a second time exposure period in the range of about 10 to about 72 hours to induce the at least one carpospore to germinate to produce at least one tetrasporophyte.

The method of the first aspect is useful for the mass production of carpospores and for the germination of carpospores and culture to the tetrasporophyte stage. In the method, the duration of the exposure periods, the light intensity and the incubation temperature are controlled to induce at least one carpospore to release from the at least one cystocarp and then to induce the at least one carpospore to germinate to produce a tetrasporophyte. As would be appreciated by the person skilled in the art, the carpospores are released from the cystocarp when they exit from the cystocarp.

The A. taxiformis carposporophyte with at least one mature cystocarp may be collected from the wild (eg, a location in the ocean where A. taxiformis grows naturally). The person skilled in the art may readily determine the carposporophyte producing season and when cystocarps have matured and are ready for producing carpospores. The person skilled in the art would understand that the season of carposporophyte occurrence in the wild is geography-dependent and typically occurs in the autumn. For example, in the Examples herein, the carposporophytes of A. taxiformis with mature cystocarps were collected from Abrolhos and Rat Islands, Western Australia, on 23 May 2022, and 13 and 20 Jun. 2022. The least one mature cystocarp may be identified by a pink to red colour on the body of cystocarp. As would be readily appreciated by the person skilled in the art, the time of year when cystocarps matured would vary, based on the season and therefore, the latitude. A germinating carpospore may be identified by the initiation of a germ tube, which begins to extend from the carpospore (has the appearance of an arrow tip). As would be appreciated by the person skilled in the art, the temperature of the water from which the carposporophyte is harvested will vary depending upon the season. For example, the temperature closer to winter may be around 16-19 degrees C. and closer to summer may be about 22-24 degrees C. As such, the water temperature will then need to be adjusted to the temperature of the first time exposure period.

Alternatively, the A. taxiformis carposporophyte with at least one mature cystocarp may be produced in an artificial environment (eg in a bioreactor). The least one mature cystocarp may be identified by a pink to red colour on the body of cystocarp.

The incubating step in the first time exposure period should preferably start within 72 hours of the carposporophyte being collected from the wild or artificial environment, more preferably within 48 hours and most preferably within 24 hours. As the person skilled in the art would appreciate, the incubating step in the first time exposure period could start after a longer period of time if the conditions closely resemble the seawater in which the A. taxiformis grows naturally.

In certain embodiments, prior to the first time exposure period, the method comprises a pre-incubation wherein the temperature of the carposporophyte (eg as provided in a medium, such as sea water) is adjusted to the incubation temperature of the first time exposure period. As such, the method comprises a pre-incubation comprising incubating the carposporophyte at a temperature that is adjusted from a first temperature to the temperature in the range of about 20 to about 26 degrees C. of the first time exposure period. In certain embodiments, the adjusting comprises increasing the temperature. In certain embodiments, the pre-incubation comprises increasing an incubation temperature of the carposporophyte from a first temperature to the temperature of the first time exposure period.

The first temperature may be, eg, the temperature of the water from which the carposporophyte is harvested or the temperature of the water in which the carposporophyte is produced. In certain embodiments, the first temperature is in the range of about 17 to about 23 degrees C. In certain embodiments, the first temperature is in the range of about 17 to about 22 degrees C., or about 18 to about 22 degrees C., such as 18, 19, 20, 21 or 22 degrees C. In certain embodiments, the temperature in the pre-incubation is adjusted in the range of about 1 to about 8 degrees. That is, the change from the first temperature to the temperature of the first time exposure period is 1 to 8 degrees. In certain embodiments, the temperature in the pre-incubation is adjusted in the range of about 1 to about 4 degrees. In particular embodiments, the temperature in the pre-incubation is adjusted in the range of about 2 to about 4 degrees.

In certain embodiments, the temperature in the pre-incubation is adjusted at a rate in the range of about 0.25 to about 3 degrees C. per hour. That is, a rate of the change in temperature is in the range of about 0.25 to about 3 degrees C. per hour. In certain embodiments, the temperature in the pre-incubation is adjusted at a rate in the range of about 1 to about 2 degrees C. per hour. In particular embodiments, the temperature in the pre-incubation is adjusted at a rate in the range of about 1 degree C. per hour. In particular embodiments, the temperature in the pre-incubation is adjusted at a rate in the range of about 0.5, about 0.6, about 0.7, about 0.8, about 0.9, about 1, about 1.1, about 1.2, about 1.3, about 1.4, about 1.5, about 1.6, about 1.7, about 1.8 or about 1.9 degrees C. per hour.

In certain embodiments in which the first temperature in high, eg, in summer when the temperature of the water from which the carposporophyte is harvested is high (eg 23, 24, 25, 26 or 27 degrees C.), an incubation temperature may be first reduced before being increased (in the pre-incubation) to a temperature of the first time exposure period (eg 20-26 degrees C.). For example, an incubation temperature (eg the water temperature or the first temperature) may be first reduced from 26, 25, 24, 23 or 22 degrees C. to a lower temperature, such as 24, 23, 22, 21, 20, 19 or 18 degrees C. In certain embodiments, a rate at which the temperature is reduced is less than 2 degrees C. per hour. In certain embodiments, a rate at which the temperature is reduced is between 0.1 and 1 degree C. per hour. In certain embodiments, a rate at which the temperature is reduced is between 0.1 and 0.5 degrees C. per hour. In certain embodiments, a rate at which the temperature is reduced is between 0.2 and 0.3 degrees C. per hour. In certain embodiments, a rate at which the temperature is reduced is about 0.25 degrees C. per hour. Following the reduction, the temperature may be increased in the pre-incubation.

In certain embodiments, a duration of the light in the first and second time exposure periods is in the range of about 16 to about 24 hours per 24 hours. In certain embodiments, the duration of the light in the first time exposure period is different to the second time exposure period. In alternative embodiments, the duration of the light in the first time exposure period is the same as the second time exposure period. In certain embodiments, the duration of the light in the first time exposure period is about 16, about 17, about 18, about 19, about 20, about 21, about 22, about 23 or about 24 hours per 24 hours, or any range between these numbers. In certain embodiments, the duration of the light in the second time exposure period is about 16, about 17, about 18, about 19, about 20, about 21, about 22, about 23 or about 24 hours per 24 hours, or any range between these numbers. In certain embodiments, the duration of the light in either or both of the first and second time exposure periods is the range of about 16 to about 18 hours per 24 hours, about 18 to about 20 hours per 24 hours, about 20 to about 22 hours per 24 hours, about 22 to about 24 hours per 24 hours, about 23 to about 24 hours per 24 hours, about 20 to about 24 hours per 24 hours or about 21 to about 24 hours per 24 hours. In certain embodiments, the duration of the light in either or both of the first and second time exposure periods is substantially continuous, eg, continuous or with greater than 23.5, 23.6. 23.7. 23.8 or 23.9 hours per 24 hours. In certain embodiments, the duration of light in the second time exposure period is sufficient to germinate the carpospores and may then be modified. As such, the person skilled in the art could monitor the germination and adjust the duration of light accordingly. For example, an initial long duration of light, eg, continuous light or 22-23 hours per 24 hours, may be sufficient to germinate the carpospores, after which the duration could be reduced to eg, 16-20 hours per 24 hours.

As mentioned above, the light intensity in the first and second time exposure periods is in the range of about 80 to about 170 μmolm⁻²s⁻¹. In certain embodiments, the light intensity in the first time exposure period is different to the second time exposure period. In alternative embodiments, the light intensity in the first time exposure period is the same as in the second time exposure period. In certain embodiments, the light intensity in the first time exposure period is about 80, about 90, about 100, about 110, about 120, about 130, about 140, about 150, about 160 or about 170 μmol m⁻²s⁻¹, or any range between these numbers. In certain embodiments, the light intensity in the second time exposure period is about 80, about 90, about 100, about 110, about 120, about 130, about 140, about 150, about 160 or about 170 μmol m⁻²s⁻¹, or any range between these numbers. In certain embodiments, the light intensity in either or both of the first and second time exposure periods is in the range of about 80 to about 170 μmolm⁻²s⁻¹, about 110 to about 170 μmolm⁻²s⁻¹, about 120 to about 170 μmolm⁻²s⁻¹, about 130 to about 160 μmolm⁻²s⁻¹, about 140 to about 150 μmolm⁻²s⁻¹, about 140 to about 160 μmolm⁻²s⁻¹, about 140 to about 170 μmolm⁻²s⁻¹, about 110 to about 160 μmolm⁻²s⁻¹, or about 100 to about 150 μmolm⁻²s⁻¹. In particular embodiments, the light intensity in either or both of the first and second time exposure periods is 140-150 μmolm⁻²s⁻¹. As would be appreciated by the person skilled in the art, the light intensity may be measured beneath the surface of the medium in which the A. taxiformis is growing and as near as is practicable to the depth of the A. taxiformis using, eg, a Full-Spectrum Underwater Quantum Meter, which accurately measures photosynthetically active radiation underwater.

As mentioned above, the method comprises incubating the carposporophyte at a temperature in the range of about 20 to about 26 degrees C. during the first and second time exposure periods. In certain embodiments, the temperature in the first time exposure period is different to the second time exposure period. In alternative embodiments, the temperature in the first time exposure period is the same as the second time exposure period. In certain embodiments, the method comprises incubating the carposporophyte at a temperature of 20, 21, 22, 23, 24, 25 or 26 degrees C. during the first time exposure period, or any range between these numbers. In certain embodiments, the method comprises incubating the carposporophyte at a temperature of 20, 21, 22, 23, 24, 25 or 26 degrees C. during the second time exposure period, or any range between these numbers. In certain embodiments, the temperature in the first time exposure period is different to the second time exposure period. In alternative embodiments, the temperature in the first time exposure period is the same as the second time exposure period. In certain embodiments, the temperature in either or both of the first and second time exposure periods is in the range of about 20 to about 25, about 20 to about 24, about 21 to about 26, about 22 to about 26, about 21 to about 25, about 22 to about 25, or about 22 to about 24 degrees C. In particular embodiments, the temperature is 22±0.5° C. or 24±0.5° C. Preferably, the temperature should not fluctuate outside of the stated ranges, as this may negatively impact the growth and/or health of the A. taxiformis. For example, temperatures of 16 degrees C. or lower, eg, 8 degrees C. may result in the death of carpospores.

As mentioned above, the duration of the first time exposure period is in the range of about 10 to about 48 hours and the duration of the second time exposure period is in the range of about 10 to about 72 hours. In certain embodiments, the duration of the first time exposure period differs from the second time exposure period. In alternative embodiments, the duration of the first time exposure period is the same as the second time exposure period. In certain embodiments, the duration of the first time exposure period is in the range of about 10 to about 42, about 10 to about 36, about 10 to about 30, about 10 to about 24, about 12 to about 42, about 12 to about 36, about 12 to about 30, about 12 to about 24, about 14 to about 42, about 14 to about 36, about 14 to about 30, about 14 to about 24, about 16 to about 42, about 16 to about 36, about 16 to about 30 or about 16 to about 24 hours. In particular embodiments, the duration of the first time exposure period is 18 to about 30 hours. In certain embodiments, the duration of the second time exposure period is about 10 to about 66, about 10 to about 60, about 10 to about 54, about 10 to about 48, about 18 to about 72, about 18 to about 66, about 18 to about 60, about 18 to about 54, about 18 to about 48, about 24 to about 72, about 24 to about 66, about 24 to about 60, about 24 to about 54 or about 24 to about 48 hours. In particular embodiments, the duration of the second time exposure period is 24-72 hours.

The product of the method of the first aspect is at least one tetrasporophyte. The produced at least one tetrasporophyte may be cultured (eg in an artificial environment) under conditions appropriate to produce a developed tetrasporophyte suitable for use in the method of the second aspect. The conditions may include the incubation temperature and light intensity of the second time exposure period, which are maintained for a period of time sufficient for the tetrasporophyte(s) to develop. In certain embodiments, the conditions include incubating the at least one tetrasporophyte at a temperature in the range of about 20 to about 26 degrees C. with exposure to light at an intensity in the range of about 30 to about 100 μmolm⁻²s⁻¹ for a third time exposure period in the range of about 16 to about 24 hours per 24 hours for about 30 to about 90 days to increase a biomass of the at least one tetrasporophyte. The conditions also include incubating the at least one tetrasporophyte at a temperature in the range of about 20 to about 26 degrees C. with exposure to light at an intensity in the range of about 30 to about 100 μmolm⁻²s⁻¹ for a fourth time exposure period of in the range of about 8 to about 16 hours per 24 hours for about 30 to about 90 days to develop the at least one tetrasporophyte to be ready to produce the at least one gametophyte. The developed at least one tetrasporophyte may be used in the method of the second aspect.

As above, the duration of the light in the third time exposure period is in the range of about 16 to about 24 hours per 24 hours. In certain embodiments, the duration of the light in the third time exposure period is about 16, about 17, about 18, about 19, about 20, about 21, about 22, about 23 or about 24 hours per 24 hours, or any range between these numbers. In certain embodiments, the duration of the light in the third time exposure period is in the range of about 16 to about 18 hours per 24 hours, about 18 to about 20 hours per 24 hours, about 20 to about 22 hours per 24 hours, about 22 to about 24 hours per 24 hours, about 23 to about 24 hours per 24 hours, about 20 to about 24 hours per 24 hours or 21 to about 24 hours per 24 hours. In certain embodiments, the duration of the light in the third time exposure period is substantially continuous, eg, continuous or with greater than 23.5, 23.6. 23.7. 23.8 or 23.9 hours per 24 hours.

As above, the duration of the light in the fourth time exposure period is in the range of about 8 to about 16 hours per 24 hours. In certain embodiments, the duration of the light in the fourth time exposure period is about 8, about 9, about 10, about 11, about 12, about 13, about 14, about 15 or about 16 hours per 24 hours, or any range between these numbers. In certain embodiments, the duration of the light in the fourth time exposure period is in the range of about 8 to about 15 hours per 24 hours, about 8 to about 14 hours per 24 hours, about 8 to about 13 hours per 24 hours, about 8 to about 12 hours per 24 hours, about 8 to about 11 hours per 24 hours, about 9 to about 16 hours per 24 hours, about 9 to about 15 hours per 24 hours, about 9 to about 14 hours per 24 hours, about 9 to about 13 hours per 24 hours, about 9 to about 12 hours per 24 hours, about 9 to about 11 hours per 24 hours, about 10 to about 16 hours per 24 hours, about 10 to about 15 hours per 24 hours, about 10 to about 14 hours per 24 hours, about 10 to about 13 hours per 24 hours, about 10 to about 12 hours per 24 hours, about 10 to about 11 hours per 24 hours, about 11 to about 16 hours per 24 hours, about 11 to about 15 hours per 24 hours, about 11 to about 14 hours per 24 hours or about 12 hours per 24 hours. In certain embodiments, about the duration of the light in the fourth time exposure period is 12±1 hour per 24 hours.

As above, the incubation temperature in the third and fourth exposure periods is in the range of about 20-26 degrees C. In certain embodiments, the incubation temperature in either or both of the third or fourth time exposure periods is about 20, about 21, about 22, about 23, about 24, about 25 or about 26 degrees C., or any range between these defined temperatures. In certain embodiments, the incubation temperature in either or both of the third or fourth time exposure periods is in the range of about 20 to about 25, about 20 to about 24, about 21 to about 25, about 21 to about 26, about 22 to about 26, about 22 to about 25, about or 22 to about 24 degrees C. In particular embodiments, the incubation temperature in either or both of the third or fourth time exposure periods is 22±1 degrees C. or 22±0.5 degrees C. Preferably, the temperature should not fluctuate outside of the stated ranges, as this may negatively impact the growth and/or health of the A. taxiformis.

As above, the light intensity in the third and fourth time exposure periods is in the range of about 30-100 μmolm⁻²s⁻¹. In certain embodiments, the light intensity in either or both of the third or fourth time exposure periods is about 30, about 40, about 50, about 60, about 70, about 80, about 90 or about 100 μmolm⁻²s⁻¹. In certain embodiments, the light intensity in either or both of the third or fourth time exposure periods is in the range of about 30 to about 90, about 30 to about 80, about 30 to about 70, about 30 to about 60, about 40 to about 90, about 40 to about 80, about 40 to about 60, about 50 to about 80, about 50 to about 70 or about 50 to about 60 μmolm⁻²s⁻¹. In particular embodiments, the light intensity in either or both of the third or fourth time exposure periods is 40-80 μmolm⁻²s⁻¹ or 50-70 μmolm⁻²s⁻¹. The light intensity may be measured as described elsewhere herein.

As above, the duration of the third time exposure period is in the range of about 30 to about 90 days and the duration of the fourth time exposure period is in the range of about 30 to about 90 days. In certain embodiments, the duration of the third exposure period differs from the fourth. In alternative embodiments, the duration of the third exposure period is the same as the fourth exposure period. In certain embodiments, the duration of either or both of the third or fourth time exposure periods is in the range of about 32 to about 88, 34 to about 86, 36 to about 84, 38 to about 82, 40 to about 80, 42 to about 78, 44 to about 76, 46 to about 74, 48 to about 72, 50 to about 70, 52 to about 68, 54 to about 66, 56 to about 64 or about 58 to about 62 days.

As would be appreciated by the person skilled in the art, the at least one tetrasporophyte is developed and ready to produce the at least one gametophyte when they are at least about 2-month-old. In the wild, A. taxiformis is in the tetrasporophyte stage during the winter. As such, A. taxiformis may remain in the tetrasporophyte stage for 2-4 months. A. taxiformis may then progress to the gametophyte stage during the spring. This means that the person skilled in the art could identify when the fourth time exposure period should end and the at least one tetrasporophyte is ready to produce the at least one gametophyte.

Alternatively, at least one A. taxiformis tetrasporophyte may be collected from the wild (eg a location in the ocean where A. taxiformis grows naturally). As above, the person skilled in the art, could identify that the tetrasporophyte collected from the wild is developed and ready to produce the at least one gametophyte when at least one tetrasporangium is present. The incubating step in the time exposure period of the second aspect should preferably start within 72 hours of the tetrasporophyte being collected from the wild or artificial environment, more preferably within 48 hours and most preferably within 24 hours. As the person skilled in the art would appreciate, the incubating step in the time exposure period could start after a longer period of time if the conditions closely resemble the seawater in which the A. taxiformis grows naturally.

According to a second aspect, there is provided a method of producing a gametophyte of A. taxiformis, comprising:
providing an A. taxiformis tetrasporophyte;
incubating the tetrasporophyte at a temperature in the range of about 20 to about 26 degrees C. with exposure to light at an intensity in the range of about 30 to about 100 μmolm⁻²s⁻¹ for a time exposure period in the range of about 5 to about 30 days to induce growth of at least one gametophyte thallus;
optionally, before inducing the growth of the at least one gametophyte thallus, first inducing formation of a tetrasporangium containing a tetraspore, inducing the tetrasporangium to release the tetraspore, and inducing the tetraspore to germinate to produce the at least one gametophyte thallus.

The method of the second aspect is useful for the mass production of gametophytes from the tetrasporophyte stage.

In certain embodiments, a duration of the light in the time exposure period is in the range of about 6 to about 18 hours per 24 hours. In certain embodiments, the duration of the light in the time exposure period is about 5, about 6, about 7, about 8, about 9, about 10, about 11, about 12, about 13, about 14, about 15, about 16, about 17 or about 18 hours per 24 hours. In certain embodiments, the duration of the light in the time exposure period is in the range of about 6 to about 17 hours per 24 hours, 6 to about 16 hours per 24 hours, 6 to about 15 hours per 24 hours, 6 to about 14 hours per 24 hours, 6 to about 13 hours per 24 hours, 6 to about 12 hours per 24 hours, 7 to about 18 hours per 24 hours, 7 to about 17 hours per 24 hours, 7 to about 16 hours per 24 hours, 7 to about 15 hours per 24 hours, 7 to about 14 hours per 24 hours, 7 to about 13 hours per 24 hours, 7 to about 12 hours per 24 hours, 8 to about 18 hours per 24 hours, 8 to about 17 hours per 24 hours, 8 to about 16 hours per 24 hours, 8 to about 15 hours per 24 hours, 8 to about 14 hours per 24 hours, 8 to about 13 hours per 24 hours or 8 to about 12 hours per 24 hours. In particular embodiments, the duration of the light in the time exposure period is 7-16 hours per 24 hours. In certain embodiments, the duration of the light in the time exposure period is substantially continuous, eg, continuous or with greater than 23.5, 23.6. 23.7. 23.8 or 23.9 hours per 24 hours.

As above, the light intensity in the time exposure period is in the range of about 30 to about 100 μmolm⁻²s⁻¹. In certain embodiments, the light intensity in the exposure period is about 30, about 40, about 50, about 60, about 70, about 80, about 90 or about 100 μmolm⁻²s⁻¹. In certain embodiments, the light intensity is about 30 to about 90, about 30 to about 80, about 30 to about 70, about 30 to about 60, about 40 to about 90, about 40 to about 80, about 40 to about 60, about 50 to about 80, about 50 to about 70, or about 50 to about 60 μmolm⁻²s⁻¹. In particular embodiments, the light intensity is 40-80 μmolm⁻²s⁻¹ or 50-70 μmolm⁻²s⁻¹. The light intensity may be measured as described elsewhere herein.

As above, the method comprises incubating the carposporophyte at a temperature in the range of about 20 to about 26 degrees C. during the time exposure period. In certain embodiments, the method comprises incubating the carposporophyte at a temperature of 20, 21, 22, 23, 24, 25 or 26 degrees C. during the time exposure period, or any range between these defined temperatures. In certain embodiments, the temperature is in the range of about 20 to about 25, about 20 to about 24, about 21 to about 25, about 21 to about 26, about 22 to about 26, about 22 to about 25 or about 22 to about 24 degrees C. In particular embodiments, the temperature is 22-24 degrees C. Preferably, the temperature should not fluctuate outside of the stated ranges, as this may negatively impact the growth and/or health of the A. taxiformis.

As above, the duration of the time exposure period is in the range of about 5 to about 30 days. As would be appreciated by the person skilled in the art, the tetrasporophyte may be monitored for induction of the growth of the at least one gametophyte thallus, which typically occurs within 5-30 days. In certain embodiments, the duration of the time exposure period is in the range of about 5 to about 28, 5 to about 26, 5 to about 24, 5 to about 22, 5 to about 20, 5 to about 18, 5 to about 16, 6 to about 14, 5 to about 12, 5 to about 10, 6 to about 28, 6 to about 26, 6 to about 24, 6 to about 22, 6 to about 20, 6 to about 18, 6 to about 16, 6 to about 14, 6 to about 12, 6 to about 10, 7 to about 20, 7 to about 18, 7 to about 16, 7 to about 14, 7 to about 12, 7 to about 10, 8 to about 12 or about 8 to about 10 days. In particular embodiments, the duration of the time exposure period is 6-12 days or about 9 days.

In certain embodiments, the method further comprises: before inducing the growth of the at least one gametophyte thallus, first inducing the formation of the tetrasporangium containing the tetraspore, inducing the tetrasporangium to release the tetraspore, and inducing the tetraspore to germinate to produce the at least one gametophyte thallus. The person skilled in the art would appreciate that the conditions for inducing the formation of the tetrasporangium containing the tetraspore, inducing the tetrasporangium to release the tetraspore, and inducing the tetraspore to germinate to produce the at least one gametophyte thallus, may be derived from published literature, for example, from conditions used to achieve the same outcome with a closely related species, A. armata. In Oza (1977), A. armata tetrasporophytes developed tetrasporangia when grown under short day conditions (8 L:16D) at 15° C., when cultured in a medium with reduced Nitrogen and Phosphorus. Similarly, in Guiry & Clinton (J. Exp. Mar. Biol. 158.2 (1992): 197-217) Irish, Italian and Australian A. armata tetrasporophytes developed tetrasporangia when grown for 5 weeks under conditions of: 15-21° C., 8-9 hours light per 24 hours for Irish plants; 17-21° C., 9-10 hours light per 24 hours for Italian plants; and 13-17° C., 8-9 hours light per 24 hours for Australian plants. Alternately, the incubation temperature, light intensity and duration of light of the above described time exposure period can be maintained for a period of time sufficient to induce the formation of the tetrasporangium containing the tetraspore, induce the tetrasporangium to release the tetraspore, and induce the tetraspore to germinate to produce the at least one gametophyte thallus.

According to a third aspect, there is provided an A. taxiformis tetrasporophyte produced by the method of the first aspect. The A. taxiformis tetrasporophyte is the product of the first aspect, so by following the method of the first aspect, an A. taxiformis tetrasporophyte is produced.

According to a fourth aspect, there is provided an A. taxiformis gametophyte produced by the method of the second aspect. The A. taxiformis gametophyte is the product of the second aspect, so by following the method of the second aspect, an A. taxiformis gametophyte is produced.

Throughout this disclosure, there are references to incubating, culturing or producing various growth stages of A. taxiformis, eg, carposporophyte, tetrasporophyte and gametophyte. As would be appreciated by the person skilled in the art, A. taxiformis may be cultured in any suitable liquid medium. The composition of the liquid medium may resemble the seawater in which the A. taxiformis grows naturally. In certain embodiments, the liquid medium may be seawater collected from where A. taxiformis grows naturally. The liquid medium may be treated to remove contaminating microorganisms. Suitable treatments include, eg, pasteurisation (eg heat treatment), sterilisation (eg UV light treatment) and/or filtration (eg using a filter with a pore size to remove contaminating organisms, eg, 0.05 to 5 μm and typically 0.2 μm). The seawater medium may also be enriched in order to provide the A. taxiformis with nutrients appropriate for growth. An example of an appropriate enriched medium is Provassoli's Enriched Seawater (Bold, H. C. & Wynne, M. J. Introduction to the Algae; 1978; Redmond et al., 2014). An enriched medium may contain, eg, macronutrients, micronutrients and/or vitamins. Other appropriate media may be found in the literature, eg, Andersen, R. A.; Jacobson, D. M. & Sexton, J. P.—Provasoli-Guillard Center for Culture of Marine Phytoplankton. Catalogue of Strains. 98 pp. West Boothbay Harbor, Maine, USA, 1991; Castenholz, R. W.—Culturing methods for Cyanobacteria. In: L. Packer and A. N. Glazer, eds., Cyanobacteria. Methods of Enzymology 167 (1988), 68-93; Guillard, R.R.L.—Culture of Phytoplankton for feeding marine invertebrates. In: W. L. Smith and M. H. Chanley, eds., Culture of marine invertebrate animals. pp. 29-60, Plenum Book Publ. Corp., New York, 1975; Kuhl, A. & Lorenzen, H.—Handling and culturing of Chlorella. In: D. M. Prescott, ed., Methods in cell physiology. Vol. 1, pp. 152-187, Academic Press, New York and London, 1964; Rippka, R. & Herdman, M.—Pasteur Culture Collection of Cyanobacterial Strains in Axenic Culture. Vol. 1, Catalogue of strains. 103 pp., Institut Pasteur, Paris, France, 1992; Starr, R. C.—Algal Cultures—sources and methods of cultivation. In: A. San Pietro, ed., Photosynthesis. Part A. pp. 29-53, Methods in Enzymology vol. 23, Academic Press, New York, 1971; Starr, R. C. & Zeikus, J. A.—UTEX—The Culture Collection of Algae at the University of Texas at Austin. J. Phycol. Suppl. 29 (1993); Stein, J. R. ed.—Handbook of phycological methods. Culture Methods and growth measurements, pp. 448, Cambridge at the University Press, London, New York, 1973; Thompson, A. S.; Rhodes, J. C. & Pettman, I.—Culture Collection of Algae and Protozoa. Catalogue of strains. 164 pp., Natural Environment Research and Council, England, 5th edit., 1988; Watanabe, M. M. & Nozaki, H.—NIES-Collection. List of strains, microalgae and protozoa. 4th edit., 127 pp. The National Institute for Environmental Studies, Japan, 1994; Werner, D.—Biologische Versuchobjekte. Kultivierung und Wachstum ausgewählter Versuchsorganismen in definierten Medien. 432 pp. Fischer Verlag, Stuttgart, New York, 1982. As would be appreciated by the person skilled in the art, the concentration of the medium may be modified depending upon the nutritional requirements of the A. taxiformis, for example, the medium may be used at the concentration described in the literature or diluted. As such, when using Provassoli's Enriched Seawater (Bold, H. C. & Wynne, M. J. Introduction to the Algae; 1978; Redmond et al., 2014), this medium may be used at the concentration described, or diluted, eg, to 50% or 25% of the described concentration. In certain embodiments, the enriched medium is undiluted (eg 100% or full strength). In other embodiments, the enriched medium is diluted to 80%, 70%, 60%, 50%, 40%, 30%, 20%, 10% or 5% of a described concentration (ie of 100% or full strength). In alternative embodiments, the concentration may be increased, eg, 2-, 3- or 4-fold relative to a described concentration.

The salinity of the liquid medium is typically that of seawater, eg, 33 parts per thousand (ppt) to 38 ppt. In certain embodiments, the salinity is in the range of about 33.5 to about 37.5, 34 to about 37.5. 34.5 to about 37.5, 35 to about 37.5, 35.5 to about 37.5, 34 to about 37, 35 to about 37, 35.5 to about 37.5, 36 to about 37. In particular embodiments, the salinity is 36.5±1 or 36.5±0.5.

The pH of the liquid medium is preferably pH 6.5 to 9. In certain embodiments, the pH is that typical of seawater, eg, between pH 8 and 9. In certain embodiments, the pH is in the range of about 6.5 to about 8.5, about 7 to about 8.5, about 7.5 to about 8, about 8.1 to about 8.8, about 8.1 to about 8.7, about 8.1 to about 8.6, about 8.1 to about 8.5, about 8.2 to about 8.8, about 8.2 to about 8.7, about 8.2 to about 8.6, about 8.2 to about 8.5, about 8.3 to about 8.8, about 8.3 to about 8.7, about 8.3 to about 8.6, about 8.3 to about 8.5 or 8.4 to about 8.5. In particular embodiments, the pH ranges from 8.4 to 8.5.

The A. taxiformis may be cultured in a bioreactor, such as a tank or flask, containing the liquid medium. The bioreactor may include an inlet and outlet for the flow of liquid medium to, eg, a reservoir of medium or an aerator. In certain embodiments, the liquid medium is aerated. Aeration may use a carbon dioxide-containing gas, such as air. As would be appreciated by the person skilled in the art, carbon dioxide-containing gas may be introduced into the liquid medium by, eg, a bubble diffuser or by removing the liquid from the bioreactor, increasing the amount of gas dissolved in the liquid and then returning the liquid to the bioreactor. The light source used to provide the light in the first and second aspects is positioned to supply light to a surface of a liquid in the bioreactor. In certain embodiments, the light source is a light emitting diode. In certain embodiments, the light source is a fluorescent light. In certain embodiments, the light source is an incandescent light.

According to a fifth aspect, there is provided a composition comprising at least one of the A. taxiformis tetrasporophyte of the third aspect, the A. taxiformis gametophyte of the fourth aspect or an extract(s) of the tetrasporophyte or gametophyte comprising one or more halogenated compound(s). The composition may be added to an animal feed and ultimately fed to a ruminant animal to reduce the number of methanogens in the rumen of the ruminant animal. In certain embodiments, the composition comprises A. taxiformis biomass. The A. taxiformis biomass is material produced by growth and/or propagation of A. taxiformis cells. Biomass may contain cells and/or intracellular contents as well as extracellular material. Extracellular material includes, but is not limited to, compounds secreted by a cell. In certain embodiments, the extract(s) include intracellular or extracellular extracts. In specific embodiments, the extract(s) include brominated compounds, such as bromoform. Asparagopsis has been known to produce halogenated low-molecular-weight compounds (Burreson B. J. et al., Tetrahedron Lett. 1975:473-476; Burreson B. J. et al. J. Agric. Food Chem. 1976; 24:856-861; Woolard F. X. et al. Tetrahedron. 1976; 32:2843-2846; McConnell O., and Fenical W. Phytochemistry. 1977; 16:367-374; Combaut G. et al. Phytochemistry. 1978; 17:1661-1663. Woolard F. X. et al. Phytochemistry. 1979; 18:617-620; Abrahamsson K. et al. Limnol. Oceanogr. 1995; 40:1321-1326; Marshall R. A et al. Limnol. Oceanogr. 1999; 44:1348-1352). As would be appreciated by the person skilled in the art, the extract(s) may be obtained using common extraction techniques, such as solvent extraction or oil immersion (Magnusson, Marie, et al. Algal Research 51 (2020): 102065; Tan, S. et al., (2022). Shelf-life stability of Asparagopsis bromoform in oil and freeze-dried powder. Journal of Applied Phycology, 1-9).

The A. taxiformis used in the composition may be dried and/or ground into meal. Drying A. taxiformis biomass, either predominantly intact or in homogenate form, helps facilitate further processing or for use of the biomass in the composition. Drying refers to the removal of free or surface moisture/water from predominantly intact biomass or the removal of surface water from a slurry of homogenised (e.g., by micronisation) biomass. In certain embodiments, the A. taxiformis biomass is drum dried to a flake form to produce A. taxiformis flake. In other embodiments, the A. taxiformis biomass is spray or flash dried (i.e., subjected to a pneumatic drying process) to form a powder containing predominantly intact cells to produce A. taxiformis powder. In further embodiments, the A. taxiformis biomass is micronised (homogenised) to form a homogenate of predominantly lysed cells that is then spray or flash dried to produce an A. taxiformis flour.

In a sixth aspect, there is provided an animal feed supplement comprising an effective amount of the composition of the fifth aspect, which comprises at least one of the A. taxiformis tetrasporophyte of the third aspect, the A. taxiformis gametophyte of the fourth aspect or an extract(s) thereof. As would be appreciated by the person skilled in the art, an effective amount is the amount required to produce a reduction in the methane emissions of the animal consuming the feed supplement. Studies have shown that dietary supplementation with 0.2%-2% A. taxiformis reduces methane emissions from ruminants by 45%-98% (Kinley et al., 2016; Li et al. 2016; Machado et al., 2016a,b; Kinley et al., 2020; Roque et al., 2021; Stefenoni et al., 2021). The amount of the composition in the animal feed supplement could be readily determined by the person skilled in the art based on these studies.

Accordingly, in a seventh aspect, there is provided a method of reducing methane emissions of a ruminant, comprising administering an effective amount of the animal feed supplement of the sixth aspect to the ruminant or administering an effective amount of the composition of the fifth aspect to the ruminant. In certain embodiments, the effective amount is 0.02% to 3% dry weight of the ruminant's diet. In particular embodiments, the effective amount is 0.02%, 0.05%, 0.1%, 0.5%, 1%, 1.5 or 2% dry weight of the ruminant's diet. The person skilled in the art would be able to formulate an appropriate dosage form and regime guided by the published literature, eg, WO2015109362A2.

### EXAMPLES

### Methods

### 1. The Method for Producing and Germinating Carpospores

### 1.1. The Method for Producing Carpospores.

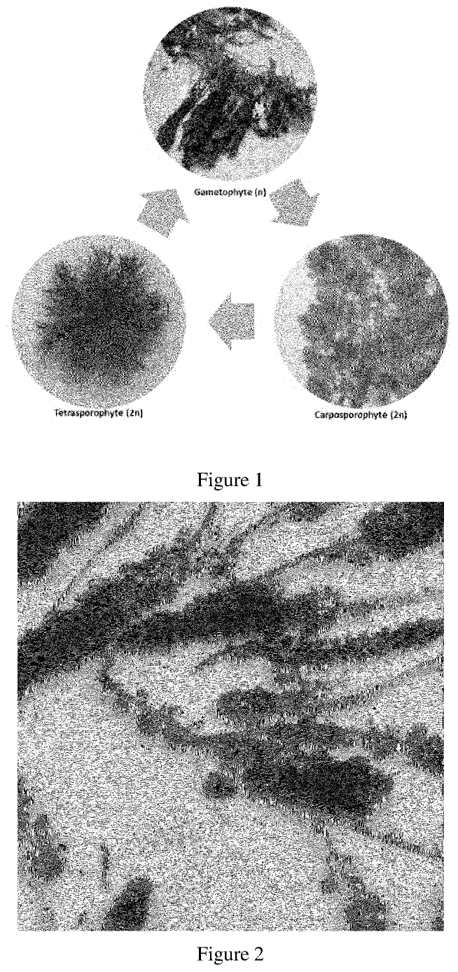

Carposporophytes of A. taxiformis with mature cystocarps were collected from Abrolhos and Rat Islands, Western Australia, via diving and snorkelling on 23 May 2022, 13 and 20 Jun. 2022 (the preliminary inducing trials were conducted on 23 May 2022 and 13/6/2022, and a complete experiment was performed on 20/6/2022). The algae were kept in fresh seawater with a similar water temperature to the collection sites. They were then transported to the hatchery within 4 hours. The inducing step was done within 24 hours. Forty branches (20-25 cm), containing 30 matured cystocarps (indicated by the pink to red colour on the body of cystocarps), were carefully selected, any visible particles or organisms were removed, and then washed with sterilised seawater (FIG. 2). Those clean branches were distributed in each of 6 white containers (430×322×127 mm). All containers were then placed in the inducing system to produce mass carpospores. The sterilised seawater was maintained at the harvest temperature of 22±0.5° C. for all the above activities.

The inducing system was built using a black steel rack (40D×90 W×180H cm) with shelving. A 36 W/830 LumiLux white OSRAM 120 cm was mounted on the top of inducing containers with the light intensity of 140-150 80 μmolm⁻²s⁻¹ (Underwater Quantum Flux, Apogee Instrument). During the inducing stage, seawater temperature was managed at 18±0.5° C., 22±0.5° C. or 24±0.5° C.

Three branches with 30 mature cystocarps were placed into each of 6 plastic Petri dishes (150 mm in diameter) to estimate the number of carpospores. Six Petri dishes were placed under 18, 22 or 24° C. water temperature. The algal branches from Petri dishes were regularly checked for carpospore release under the microscope after 18 h until 30 h after inducing. The empty cystocarps were counted under a microscope (magnification of 5×).

Three follow-up inductions were conducted at different times of the year. In a first experiment, a temperature of the seawater at harvest was 18° C. The temperature was increased at 1° C. per hour up to the temperature of 22±0.5° C. for the inducing stage. In a second experiment, a temperature of the seawater at harvest was 22° C. The temperature was increased at 1° C. per hour up to the temperature of 26±0.5° C. for the inducing stage. In a third experiment, a temperature of the seawater at harvest was 22° C. The temperature was first decreased to 18° C. over 16 hours, then increased at 1° C. per hour up to the temperature of 22±0.5° C. for the inducing stage.

$$Hatching cystocarps rate ( \% ) = ( Number of hatching cystocarps / Number of matured cystocarps ) * 100$$

$$The ratio of carpospores and cystocarps = Numbers of carpospores / Number of matured cystocarps$$

$$The ratio of carpospores per hatching cystocarps = Numbers of carpospores / hatching cystocarps .$$

### 1.2. The Method of Germinating Carpospores.

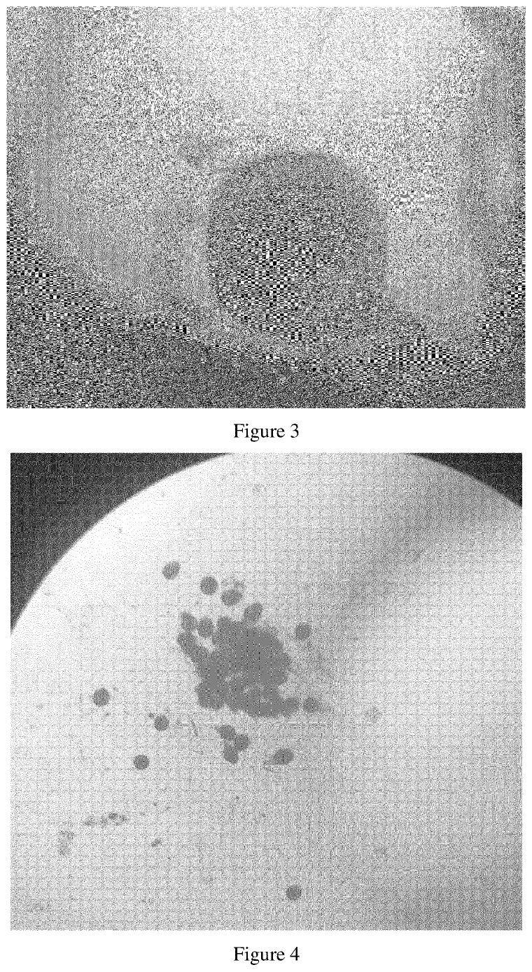

For germination, all branches from the carpospore-inducing step above were removed from white containers and Petri dishes. The attached carpospores on the bottom of white containers and Petri dishes were rinsed with sterilised seawater that was 18, 22 or 24° C. water temperature, respectively. The carpospores were kept under constant light at a light intensity of 140-150 80 μmolm⁻²s⁻¹ in the water at 18, 22 and 24° C. Germination was observed 24 hours after the first carpospores were released in the above—inducing step, and for the next 48-72 hours. The carpospores were checked under a microscope and recorded for signs of germination, which was indicated by the presence of emerging germ tubes (ie arrow tips) on carpospores (FIGS. 3 and 4). The germination rate was then calculated as:

$$Germination rate ( \% ) = ( Number of germinated carpospores / Numbers of carpospores ) * 100$$

$$The ratio of germinated carpospores / cystocarps = germinated carpospores / matured cystocarps$$

### 2. Method of Producing Gametophytes

### 2.1. Tetrasporophyte Material

Tetrasporophytes were induced from the carposporophyte stage, and cultured in 5 L bottles at 22° C.±0.5 using UV light-treated seawater and under the conditions of 24 h light, half strength of PES, 60 μmolm⁻²s⁻¹ light intensity, salinity 36.5 ppt, pH: 8.4-8.5 for two months to obtain the mass production. After two months, tetrasporophytes were grown under the same condition, but the light intensity was reduced to 12 hours of light and 12 hours of dark (12 L/12D). Four-month-old tetrasporophytes were selected for producing the gametophyte stage.

### 2.2. The System Design for Producing the Gametophyte of A. Taxiformis

A trial was set up to determine the environmental conditions of photoperiod and nutrition level for producing gametophytes from tetrasporophytes. Four culturing cabinets (60H×120 L×60 W) were designed to maintain the light intensity of 60 μmolm⁻²s⁻¹, using Philips fluorescent 30 W, mounted on the top of culturing flasks. The cultures were provided with a general normal air supply from an air generator.

The water and air temperature was controlled at 24 and 22±0.5° C., respectively. Before culturing, the seawater was filtered through 0.2 μm filtration and treated with UV light. The salinity was maintained at 36.5ppt, and pH ranged from 8.4 to 8.5.

The trial was carried out to investigate gametophyte production under different photoperiods and nutrition levels. The photoperiods were set at 8 hours of light and 16 hours of dark (8 L/16D); 12 L/12D; 16 L/8D; 24 L, whereas the nutrition levels were tested as half-strength PES (10 ml/L) and full-strength PES (20 ml/L) (Redmond et al., 2014).

The tetrasporophytes were harvested from 5-L glass bottle culturing system. First, the tissue papers were used to remove the excess water and then tetrasporophytes were weighed out and recorded as initial weight. Tetrasporophyte were distributed in each of 24 flasks (250 ml flask) at the density of 0.4 g/L. The experiment was carried out for 9 days.

### 2.3. Specimen Sampling and Analyses

At the beginning of the trial, the tetrasporophytes were photographed and carefully checked under the microscope to ensure they were healthy and contamination-free.

### Gametophyte Production Under Different Photoperiods and Nutrition Levels

The presence of young gametophytes from each culture was recorded, and the numbers of young gametophyte thalli were counted and pictured under a microscope (magnification of 5×).

### Performance of Tetrasporophytes Under Different Photoperiods and Nutrition Levels

The tetrasporophytes were weighed at the beginning and the end of the trial (day 9). The performance was evaluated as follows:

$$Biomass gain ( g ) = {W}_{F} - {W}_{I}$$

$$SGR ( \% / ngày ) = [ ( {LnW}_{F} - {LnW}_{I} ) / t ] \times 100$$

$$WG ( \% ) = [ ( {W}_{F} - {W}_{I} ) / {W}_{I} ] \times 100$$

$$Yield / {m}^{3} ( g ) = WG \% \times {W}_{s}$$

Whereas: SGR: specific growth rate; WG: Weight gain; W_{F}: Final weight; W_{I}: Initial weight; Ws: Initial weight of algae stocked in 1 m³.

### 3. Statistical Analysis

Statistics were computed using Statistical Package for the Social Sciences (SPSS) for Windows (Version 22, IBM Corp., Armonk, NY, USA). To ensure normal distribution, Levene's test for equality of variance was used to assess the homogeneity of variance among means and Independent-Samples T-test was used to compare the hatching cystocarps rate, the ratio of carpospores and cystocarps, ratio of carpospores and hatching cystocarps, germination rate (%) and the ratio of germinated carpospores/cystocarps at 22° C. against 24° C.

To assess the effects of nutrient levels and photoperiods on gametophyte production and tetrasporophyte performance, the data were analysed using a two-factor ANOVA. Tukey's HSD post hoc test was used to detect significant differences between treatment means when significant main effects were observed. A significance level of p<0.05 was used for all statistical tests. All values are presented as means±standard error of the mean.

### Results

### 3.1. Inducing Carpospores

The inducing method was successfully repeated three times on 23/5/2022, 13/6/2022 at 22° C. water temperature and 20/6/2022 at 18, 22 and 24° C. water temperatures. The results were consistently observed.

The cystocarps started releasing carpospores after 18 hours at 24° C. or 24 hours at 22° C. water temperature. The cystocarps did not release carpospores at 18° C. The carpospores were observed in all white containers and all Petri dishes. There were no significant differences in terms of hatching cystocarps rate, the ratio of carpospores and cystocarps and the ratio of carpospores and hatching cystocarps between two temperatures of 22 and 24° C. (Table 1). The percent hatching rate of cystocarps was from 5.92±0.74% to 6.67±0.64%.

TABLE 1
ASPARAGOPSIS TAXIFORMIS CARPOSPORE
PRODUCTION AND GERMINATION AT 22
AND 24° C. WATER TEMPERATURE

| | Water temperature (° C.) | | T-Test |
|---|---|---|---|
| | 22 | 24 | (p-value) |
| Hatching cystocarps | 5.92 ± 0.74 | 6.67 ± 0.64 | 0.491 |
| rate (%) | | | |
| Ratio of carpospores | 2.85 ± 1.08 | 3.00 ± 0.11 | 0.898 |
| and cystocarps | | | |
| Ratio of carpospores and | 47.10 ± 14.40 | 46.10 ± 5.55 | 0.950 |
| hatching cystocarps | | | |
| Germination rate (%) | 60.53 ± 9.06 | 70.33 ± 1.40 | 0.393 |
| Ratio of germinated | 1.53 ± 0.30 | 2.11 ± 0.06 | 0.184 |
| carpospores/cystocarps | | | |

The results obtained on 23/5/2022 and 13/6/2022 were consistent with those of 20/6/2022. However, temperature aberrations resulted in the death of the spores. For the method of 23/5/2022, the spores were transported on an aeroplane and the temperature dropped to approximately 8° C. All spores died. For the method of 13/6/2022, the temperature of the growth room dropped to 16° C. overnight. All spores died.

The three follow-up inductions successfully induced cystocarps to release carpospores.

### 3.2. Carpospore Germination

The first sign of germination was observed at 18 hours and 22 hours after carpospores were released at 24° C. and 22° C. water temperatures, respectively. No significant difference was observed in germination rate and the ratio of germinated carpospores/cystocarps between 22 and 24° C. water temperature (Table 1). The germination rate ranged from 60.53±9.06% to 70.33±1.40%.

TABLE 2
THE TETRASPOROPHYTE PERFORMANCE, GAMETOPHYTE PRODUCTION AND BROMOFORM CONTENT
OF ASPARAGOPSIS TAXIFORMIS UNDER DIFFERENT PHOTOPERIODS AND NUTRITION LEVELS

| | | | | | | | | | ANOVA | | | | | |
|---|---|---|---|---|---|---|---|---|---|---|---|---|---|---|
| | | | | | | | | | Nutrition | | | | | Inter- |
| Nutrition | Half strength (H) | | | | Full strength (F) | | | | (A) | Light (B) | | | | action |
| Light (L/D) | 8/16 | 12/12 | 16/8 | 24/0 | 8/16 | 12/12 | 16/8 | 24/0 | (H) (F) | 8/16 | 12/12 | 16/8 | 24/0 | A × B |
| Initial (g) | 0.105 | 0.102 | 0.103 | 0.105 | 0.106 | 0.103 | 0.103 | 0.104 | NS | NS | | | | NS |
| Final weight (g) | 0.236 | 0.404 | 0.392 | 0.561 | 0.175 | 0.434 | 0.501 | 0.630 | NS | A | AB | B | B | NS |
| Weight gain (g) | 0.131 | 0.302 | 0.290 | 0.456 | 0.070 | 0.330 | 0.398 | 0.526 | NS | A | AB | B | B | NS |
| SGR (%/day) | 8.74 | 14.65 | 14.76 | 18.38 | 5.66 | 15.32 | 17.05 | 19.94 | NS | A | B | B | B | NS |
| WG (%) | 123.4 | 297.7 | 281.3 | 436.7 | 67.0 | 321.8 | 386.3 | 506.7 | NS | A | B | B | B | NS |
| Yield/m³/day (g) | 58.06 | 134.44 | 128.68 | 202.88 | 31.29 | 146.79 | 177.03 | 233.96 | | | | | | |
| Numbers of | 1.667 | 0.333 | 0.333 | 0.000 | 3.333 | 1.000 | 0.000 | 0.333 | NS | A | B | B | B | NS |
| thalli/treatment | | | | | | | | | | | | | | |

*NS indicates no significant different with P > 0.05;
** DW presents as dry weight of tetrasporophyte.
L is light.
D is dark.
Half strength PES medium is H.
Full strength PES medium is F.
(Provassoli's Enriched Seawater) media

### 3.3. The Tetrasporophyte Performance Under Different Photoperiods and Nutrition Levels

The performance of tetrasporophytes was photoperiod-dependent, whereas no significant differences were found in growth among treatments caused by different nutrition levels (Table 2). No interaction was found between nutrition levels and photoperiods.

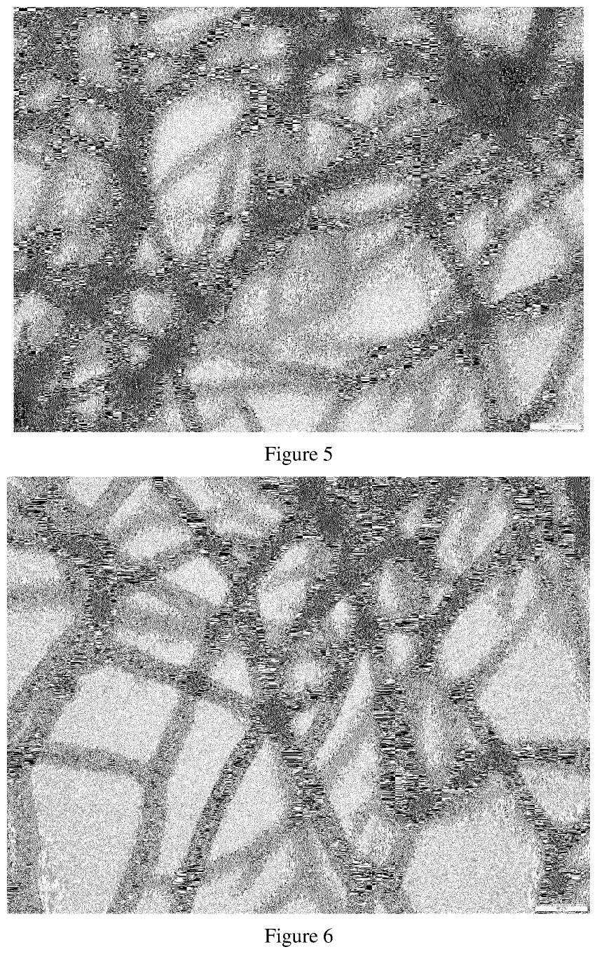

The biomass gain of tetrasporophytes under 24 hours of light was significantly higher than that cultured under 8 hours of light. However, there were no significant differences in the biomass gain of tetrasporophytes among photoperiods of 24, 16 and 12 hours of light. Healthy tetrasporophytes of A. taxiformis under conditions of 8 hours of light per 24 hours are shown in FIG. 5. Although the highest growth rate of tetrasporophyte was recorded from the 24 hours light treatment, the culture visually lost the red colour at the end of the experiment (FIG. 6).

### 3.4. Gametophyte Production Under Different Photoperiods and Nutrition Levels

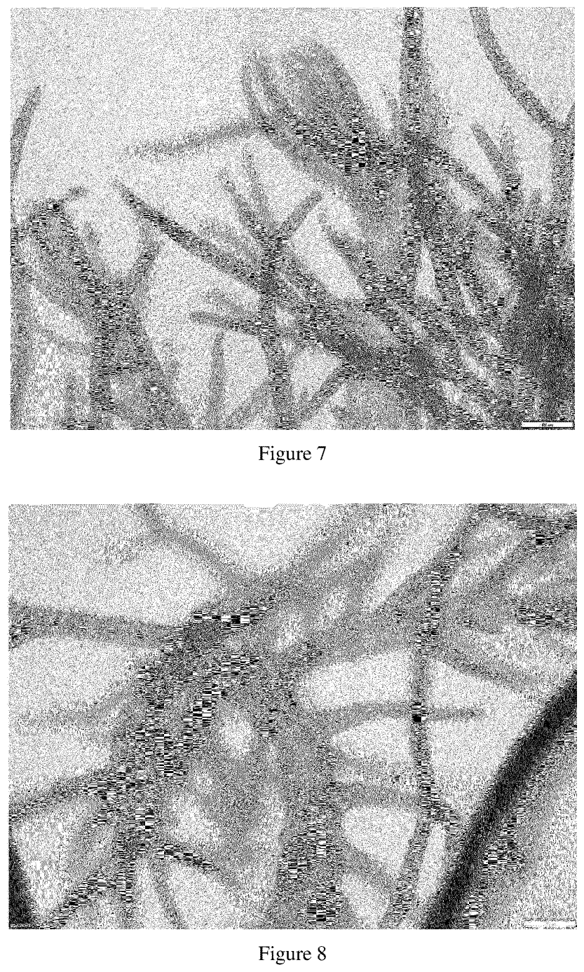

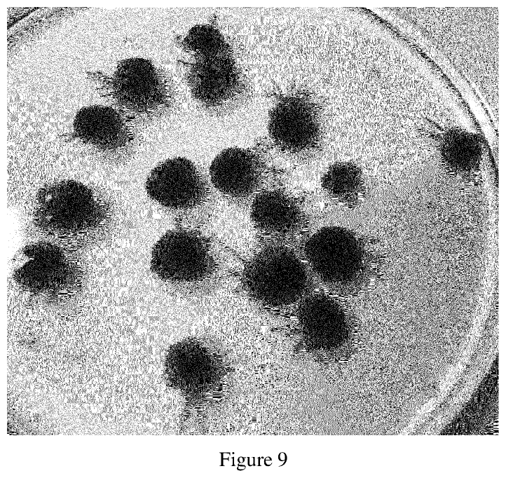

Tetrasporophytes cultured under 8 hours of light/16 hours of dark produced significantly more gametophytes than those from other treatments, and the gametophytes were observed in 5 out of 6 cultures. The number of gametophyte thalli was also significantly higher under photoperiods of 8 hours of light/16 hours of dark than those grown under other light periods (p<0.05). Young gametophytes of A. taxiformis under 5× magnification from an 8 L/16D treatment are shown in FIG. 7. Interestingly, the gametophyte thalli were observed within 9 days of culturing in this research without developing the tetrasporangium and the presence of tetraspores. (FIG. 8). This finding helps to significantly shorten the time to produce gametophytes. Young gametophytes are shown in FIG. 9.

### DISCUSSION

### The Method for Inducing Mass Production of Carpospores

The carposporophyte producing season and maturation of cystocarps for producing carpospores led to the production of tetrasporophytes for use in the culturing system. The season of carposporophyte occurrence in the wild is geography-dependent, however, they generally become abundant and mature in the autumn. Based on our record, the first time carposporophytes were observed was on 3/2022 in the Abrolhos Islands, Western Australia, but the cystocarps were small and still developing. The second collection was on 19/5/2022, and some cystocarps had a red colour on their body, indicating their maturation. The third and fourth observations were done on 13/6/2022 and 19/6/2022, respectively, when more mature cystocarps were found. According to the aquaculture manager in Abrolhos Islands, some cystocarps are still observed in 9/2022 (September), but their colour was faint indicating the end of the season.

Several methods have induced the algal carpospores in species other than A. taxiformis, such as desiccating mature reproductive thalli (Andersen 2005; Avila et al. 2011) or introducing the thalli in complete darkness and then transferring to high light intensity (Andersen 2005). However, limited information has been found regarding inducing carpospores in A. taxiformis. The inducing method in the current study exposed the mature cystocarps to high light intensity at 22 and 24° C. water temperature, which provided a large production of carpospores, and ultimately tetrasporophytes.

Based on our observations, the hatching rate and number of carpospores was dependent on the degree of maturation in cystocarps. A higher degree of maturation resulted in a higher hatching rate and number of carpospores. As above, a pink to red colour indicates maturation.

### The Method for Germinating Carpospores

The germination process of carpospores has been described in A. armata and other red algal species (Bonin and Hawkes, 1987; Orduña-Rojas and Robledo, 1999; Oza and Krishnamurty, 1967, Oza 1975). However, limited information is available for A. taxiformis, especially regarding technique of inducing carpospores. The current study was performed to test the effect of water temperatures of 22 and 24° C. on the germination rate of carpospores. Based on our preliminary trial, germination was recorded at 22 and 24° C., but not at 18° C. water temperature. The germination time was shorter at the higher water temperature.

### The Method for Producing Mass Production of Gametophytes

The source of tetrasporophyte used for gametophyte production in this research was from the culture system that was continued from the previous inducing and germinating carpospore step. The gametophytes are produced when the tetrasporophytes are about four-month-old. It is generally expected that Asparagopsis species will develop through the tetrasporangium stage and release tetraspores once a combination of photoperiod and water temperature triggers them. It takes 4 to 8 weeks for tetraspores to be released and germinated (Oza 1977; Lüning 1981; Rojas et al. 1982, Guiry and Dawes 1992; Ní Chualáin et al. 2004). However, the gametophyte thalli were uniquely observed within 9 days of culturing in this research without developing the tetrasporangium and the presence of tetraspores. A similar observation in A. taxiformis from Rottnest I (Western Australia) was reported by Ní Chualáin et al. (2004).

### REFERENCES

Abbott, D. W. et al., 2020. Seaweed and seaweed bioactives for mitigation of enteric Methane: Challenges and Opportunities. Animals, 10, 2432.
Andersen, R. A. 2005. Algal culturing techniques. Academic Press, Burlington, MA, USA.
Avila, M. et al., 2011. Cultivation of the red alga Chondracanthus chamissoi: sexual reproduction and seedling production in culture under controlled conditions. Journal of Applied Phycology 23:529-536.
Bačeninaitė, D. et al., 2022. Global warming and dairy cattle: How to control and reduce methane emission” Animals, 12 (19), 2687.
Bonin, D. R. et al., (1987). Systematics and life histories of New Zealand Bonnemaisoniaceae (Bonnemaisoniales, Rhodophyta): I. The genus Asparagopsis. New Zealand Journal of Botany, 25(4), 577-590.
Howarth, R. W. (2014). A bridge to nowhere: methane emissions and the greenhouse gas footprint of natural gas. Energy Science & Engineering, 2(2), 47-60.
Intergovernmental Panel on Climate Change. (2015). Climate Change 2014: Mitigation of Climate Change: Working Group III Contribution to the IPCC Fifth Assessment Report. Cambridge: Cambridge University Press. doi:10.1017/CBO9781107415416 (accessed on 23 Dec. 2022).
Karakurt, I. et al., (2012). Sources and mitigation of methane emissions by sectors: a critical review. Renewable energy, 39(1), 40-48.
Kinley, R. D. et al., (2020). Mitigating the carbon footprint and improving productivity of ruminant livestock agriculture using a red seaweed. Journal of Cleaner Production, 259, 120836.
Kinley, R. D. et al., 2016. The red macroalgae Asparagopsis taxiformis is a potent natural antimethanogenic that reduces methane production during in vitro fermentation with rumen fluid. Anim. Prod. Sci., 56, 282-289.
Li, X. et al., (2016). Asparagopsis taxiformis decreases enteric methane production from sheep. Animal Production Science, 58(4), 681-688.
Machado, L. et al., (2015). The potential of macroalgae for beef production systems in Northern Australia. Journal of Applied Phycology, 27(5), 2001-2005.
Machado, L. et al., (2016a). Identification of bioactives from the red seaweed Asparagopsis taxiformis that promote antimethanogenic activity in vitro. Journal of Applied Phycology, 28(5), 3117-3126.
Machado, L. et al., 2016b). Dose-response effects of Asparagopsis taxiformis and Oedogonium sp. on in vitro fermentation and methane production. Journal of Applied Phycology, 28(2), 1443-1452.
Mata, L (2008) Integrated aquaculture of Bonnemaisoniaceae: physiological and nutritional controls of biomass production and of halogenated metabolite content. PHD Thesis, University of Algarve, Portugal 176 pp.
Mata, L. et al., (2012) Carbon/nutrient balance in relation to biomass production and halogenated compound content in the red alga Asparagopsis taxiformis (Bonnemaisoniaceae). J Phycol 48:248-253.
Mata, L. et al., (2017) Within-species and temperature-related variation in the growth and natural products of the red alga Asparagopsis taxiformis. J Appl Phycol 29:1437-1447.
Mata, L. et al., (2010) A direct comparison of the performance of the seaweed biofilters, Asparagopsis armata and Ulva rigida. J Appl Phycol 22:639-644.
Mata, L. et al., (2006) The effects of light and temperature on the photosynthesis of the Asparagopsis armata tetrasporophyte (Falkenbergia rufolanosa), cultivated in tanks. Aquaculture 252:12-19
Mata L. et al., (2007) Is the tetrasporophyte of Asparagopsis armata (Bonnemaisoniales) limited by inorganic carbon in integrated aquaculture? J Phycol 43:1252-1258.
Ní Chualáin F. N. et al., (2004) The invasive genus Asparagopsis (Bonnemaisoniaceae, Rhodophyta): molecular systematics, morphology, and ecophysiology of Falkenbergia isolates. J Phycol 40:1112-1126
Orduña-Rojas, J., and Robledo, D. (1999). Effects of irradiance and temperature on the release and growth of carpospores from Gracilaria cornea J. Agardh (Gracilariales, Rhodophyta). Botanica Marina, 42 (4), 314
Oza, R. M. 1975. Studies on Indian Gracilaria. I. Carpospore and tetraspore germination and early stages of development in Gracilaria corticata J. Ag. Bot. March 18:199-201.
Oza, R. M. 1977. Culture studies on introduction of tetraspores and their subsequent development in the red alga Falkenbergia rufolanosa. Bot. March 20:29-32.
Oza, R. M. and V. Krishnamurthy. 1967. Carpospore germination and early stages of development in Gracilaria verrucosa (Huds.) Papenf. Phykos 6:84286.
Paul, N. A. et al., (2006). Ultrastructure of the gland cells of the red alga Asparagopsis armata (bonnemaisoniaceae) 1. Journal of Phycology, 42(3), 637-645.
Redmond, S. et al., (2014). New England seaweed culture handbook-nursery systems.
Schuenhoff A. et al., (2006) The tetrasporophyte of Asparagopsis armata as a novel seaweed biofilter. Aquaculture 252:3-11.
Stefenoni, H. A. et al., (2021). Effects of the macroalga Asparagopsis taxiformis and oregano leaves on methane emission, rumen fermentation, and lactational performance of dairy cows. Journal of dairy science, 104(4), 4157-4173.
Tan, S. et al., (2022). Shelf-life stability of Asparagopsis bromoform in oil and freeze-dried powder. Journal of Applied Phycology, 1-9.
Zanolla, M. et al., (2014). Morphological differentiation of cryptic lineages within the invasive genus Asparagopsis (Bonnemaisoniales, Rhodophyta). Phycologia, 53(3), 233-242.
Zanolla, M. et al., (2022). Concise review of the genus Asparagopsis Montagne, 1840. Journal of Applied Phycology, 1-17.

The methods of the present disclosure are industrially applicable as they may enable the production and germination of carpospores that can quickly lead to the mass production of tetrasporophytes. The methods may also provide for a high quality and quantity of carpospores and with a high germination rate due to the use of a natural induction method. The methods may also enable the rapid production of a large number of gametophytes. Practicing the methods may be done with a low cost input as the production equipment is not complex and the labour requirement is low.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may combine multiple features for succinctness and/or to assist in understanding the scope of the disclosure. In such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. A method of producing at least one tetrasporophyte of Asparagopsis taxiformis, comprising:
providing an A. taxiformis carposporophyte with at least one mature cystocarp;
incubating the carposporophyte at a temperature in the range of about 20 to about 26 degrees C. and with exposure to light at an intensity in the range of about 80 to about 170 μmolm⁻²s⁻¹ for a first time exposure period in the range of about 10 to about 48 hours to induce at least one carpospore to release from the at least one cystocarp;
incubating the at least one carpospore at a temperature in the range of about 20 to about 26 degrees C. with exposure to light at an intensity in the range of about 80 to about 170 μmolm⁻²s⁻¹ for a second time exposure period in the range of about 10 to about 72 hours to induce the at least one carpospore to germinate to produce the at least one tetrasporophyte.

2. The method of claim 1, wherein a duration of the light in either or both of the first and second time exposure periods is about 16 to about 24 hours per 24 hours.

3. (canceled)

4. The method of claim 1, wherein the light intensity in either or both of the first and second time exposure periods is in the range of about 120 to about 170 μmolm⁻²s⁻¹.

5. (canceled)

6. The method of claim 1, wherein the incubation temperature in either or both of the first and second time exposure periods is in the range of about 21 to about 25 degrees C.

7. The method of claim 1, wherein the incubation temperature either or both of the first and second time exposure periods is in the range of about 22 to about 24 degrees C.

8. The method of claim 1, further comprising a pre-incubation comprising incubating the carposporophyte at a temperature that is adjusted from a first temperature to the temperature of the first time exposure period.

9. The method of claim 8, wherein the first temperature is in the range of about 17 to about 23 degrees C.

10. The method of claim 8, wherein the temperature in the pre-incubation is adjusted in the range of about 1 to about 8 degrees.

11. The method of claim 8, wherein the temperature in the pre-incubation is adjusted at a rate in the range of about 0.25 to about 3 degrees C. per hour.

12. A method of producing at least one gametophyte of Asparagopsis taxiformis, comprising:
providing an A. taxiformis tetrasporophyte;
incubating the tetrasporophyte at a temperature in the range of about 20 to about 26 degrees C. with exposure to light at an intensity in the range of about 30 to about 100 μmolm⁻²s⁻¹ for a time exposure period in the range of about 5 to about 30 days to induce growth of at least one gametophyte thallus;
optionally, before inducing the growth of the at least one gametophyte thallus, first inducing formation of a tetrasporangium containing a tetraspore, inducing the tetrasporangium to release the tetraspore, and inducing the tetraspore to germinate to produce the at least one gametophyte thallus.

13. The method of claim 12, wherein a duration of the light in the time exposure period is in the range of about 6 to about 18 hours per 24 hours.

14. The method of claim 13, wherein the duration of the light in the time exposure period is in the range of about 7 to about 16 hours per 24 hours.

15. The method of claim 12, wherein the light intensity in the time exposure period is in the range of about 40 to about 80 μmolm⁻²s⁻¹

16. (canceled)

17. The method of claim 12, wherein the temperature in the time exposure period is in the range of about 21 to about 25 degrees C.

18. (canceled)

19. The method of claim 12, wherein the time exposure period is in the range of about 6 to about 21 days.

20. The method of claim 12, further comprising: before inducing the growth of the at least one gametophyte thallus, first inducing the formation of the tetrasporangium containing the tetraspore, inducing the tetrasporangium to release the tetraspore, and inducing the tetraspore to germinate to produce the at least one gametophyte thallus.

21. The method of claim 12, wherein the tetrasporophyte is produced by the method of claim 1.

22. The method of claim 21, wherein the at least one tetrasporophyte is developed to be ready to produce the at least one gametophyte by steps comprising:
incubating the at least one tetrasporophyte at a temperature in the range of about 20 to about 26 degrees C. with exposure to light at an intensity in the range of about 30 to about 100 μmolm⁻²s⁻¹ for a third time exposure period in the range of about 16 to about 24 hours per 24 hours for about 30 to about 90 days to increase a biomass of the at least one tetrasporophyte; and
incubating the at least one tetrasporophyte at a temperature in the range of about 20 to about 26 degrees C. with exposure to light at an intensity in the range of about 30 to about 100 μmolm⁻²s⁻¹ for a fourth time exposure period in the range of about 8 to about 16 hours per 24 hours for about 30 to about 90 days to develop the at least one tetrasporophyte to be ready to produce the at least one gametophyte.

23. (canceled)

24. (canceled)

25. A composition comprising an A. taxiformis tetrasporophyte produced by the method of claim 1, a A. taxiformis gametophyte produced by the method of claim 12 or an extract(s) of the tetrasporophyte or the gametophyte comprising one or more halogenated compound(s).

26. (canceled)
